(19) United States
(12) Patent Application Publication
(10) Pub. No.: US 2006/0225138 A1
(43) Pub. Date: Oct. 5, 2006

(54) End-to-end digital media entitlement system

(76) Inventors: Takeshi Toyohara, New York, NY (US); Mike Stanley, Atlanta, GA (US); Matthew Narrell, New York, NY (US); Russell Zack, New York, NY (US); Steve Salzinger, Scarsdale, NY (US); Jeff Sherwin, Brooklyn, NY (US); Jon Farb, New York, NY (US)

Correspondence Address: SOFER & HAROUN, L.L.P.;Suite 910, 317 Madison Avenue, New York, NY, 10017, US

(21) Appl. No.: 11/172,426

(22) Filed: Jun. 30, 2005

Related U.S. Application Data
(60) Provisional application No. 60/667,789, filed on Apr. 2, 2005.

(51) Int. Cl. H04L 9/32

(52) U.S. Cl. 726/27

(57) ABSTRACT

A system for creating and processing customer entitlement rules employs a first interface for creating customer entitlement rules and a second interface for communicating with a portal for consuming digital content entitled to. An entitlement engine processes the entitlements, and the system interfaces with a plurality of modules in order to obtain data needed to make entitlement decisions. The entitlement engine allows digital content providers to track, secure and manage entitlements for the digital content.

### REFERENCE TO RELATED APPLICATIONS

This application is related to and claims the benefit of priority to co-pending U.S. patent application Ser. No. 10/359,770, filed on Dec. 30, 2004, and U.S. Provisional Patent Application No. 60/667,789, filed on Apr. 2, 2005, the entirety of which are incorporated herein by reference.

### FIELD OF THE INVENTION

The present invention relates to a digital media system. More particularly, the present invention relates to a rules creation and management process that enables consumers to access, view and/or purchase a variety of digital media.

### BACKGROUND OF INVENTION

The landscape for companies delivering digital content has changed significantly in recent years. Competition has stiffened as new entrants in the market strive to take advantage of vast advances in technology, a reduction in backend processing costs, and the rise in consumer demand for digital products and services. Content owners, producers, and distributors (referred to here forth as media providers) want to ensure that content is securely protected, the rights access to content is easily managed, and ultimately that customers have a simple, yet gratifying experience when purchasing and consuming content.

As digital media grows in popularity and the available types of digital content expands, rights information associated with this content also increases. Rights information may be linked with certain customer and/or product attributes. This information has the potential to grow exponentially as the number of attributes (customer and product) and business models increase, the need for tools that help media providers to manage such data in an automated fashion also escalates.

Further, as the amount of valuable content made available digitally increases, the desire to protect it also grows. To ensure the integrity of their content, media providers have traditionally relied on limited content protection technologies that are typically either device/technology driven or those that focus only on securing a specific part of the content ordering process. However, such technology has not proven to be robust enough to meet the varied needs of today's media providers.

It is nonetheless important to note that technological advances have made it possible for media providers to offer content licenses under a variety of contexts and terms. However, they have come short of being able to adequately meet the growing consumer demand for tools that are designed to help them to better control their media consumption experience irrespective of content type, time, location and device. Presently, a solution that appropriately responds to consumer requests in such a manner, while simultaneously providing the support media providers require to attain their business objectives, does not exist.

### OBJECTS AND SUMMARY OF INVENTION

The present invention provides a solution to the drawbacks associated with the prior art and serves as an end-to end Entitlement Engine that can be described as a system that processes all the rules surrounding content a consumer may have a right or claim to and the interfaces required for accessing this logic. The Entitlement Engine responds to consumer requests with either authorization or alternatives to the desired content. It offers consumers the flexibility to access, download, purchase and share a variety of different types of content over a diverse set of devices. Further, it supports the exchange of any type of digital content such as audio, video or games over devices including PCs, TVs and game consoles (among a number of consumer electronics).

The present invention provides an automated method for managing, filtering and routing complex rules tailored to securely control the access and rights to specified content. It ensures the integrity of digital media throughout the content ordering process by facilitating a consumer's ability to initiate the order of a digital product or service based on their status (subscriber entitlements), initiating the requirements for viewing and/or purchasing a digital offer or package (offer entitlement), using license parameters associated with a specific piece of content (license entitlement) validating the rules for a transaction (transaction entitlement), posting the transaction policies on purchased services or products (service entitlement) and providing parental-type controls that may be based on a consumer's primary or secondary account status (access entitlements).

In one embodiment of the invention, a Web interface for creating, manipulating and managing entitlement rules is provided in addition to four components. The first component, External Interfaces and Request Handler, consists of a set of inbound interfaces that accept entitlement requests. Another component is the Rule Engine which contains the logic necessary for entitlement decisions and is responsible for the processing of all entitlement requests. Additionally, the State Change and Exception Logger is charged with logging application events from the Entitlement Engine. The fourth component is the External Data Source Interface, it provides the Entitlement Engine with interfaces required to appropriately request data from external systems such as a media provider's EIS systems.

The present invention enables media providers to maintain a consumer-orientated approach while protecting content and efficiently managing rights data. Using a configurable rule-based engine and EIS drivers and adapters, it furnishes media providers with the mechanisms required to distribute varied offerings tailored to suit consumer demand. The invention gives media providers the flexibility to manage a variety of business models, content types and rights data while securing each step of the content ordering process. It enables media providers to manage the creation and processing of entitlement rules in an efficient and secure manner.

To this end the present invention provides for a system for processing rules regarding customer access rights to digital content. The system includes a first interface for communicating with a customer portal and an entitlement engine for receiving content requests from the customer portal. The entitlement engine is configured to interface with a plurality of modules in order to obtain rules regarding customer access rights to the content requested by the customer portal. The entitlement engine allows end-user digital content providers to track secure and manage entitlements for the digital content.

### BRIEF DESCRIPTION OF DRAWINGS

The subject matter regarded as the invention is particularly pointed out and distinctly claimed in the concluding portion of the specification. The invention, however, both as to organization and method of operation, together with features, objects, and advantages thereof, may best be understood by reference to the following detailed descriptions when read with the accompanying drawings:

FIG. 1: is a high-level diagram of the Entitlement Engine, in accordance with one embodiment of the present invention;

FIG. 2: is a diagram of the components of the Entitlement Engine from FIG. 1, and associated interfaces, in accordance with one embodiment of the present invention;

FIG. 3: is a diagram of the workflow request states, in accordance with one embodiment of the present invention;

FIG. 4: is a flow chart of a content request and approval process in accordance with one embodiment of the present invention;

FIG. 5: is a flow chart illustrating an authorization to download content scenario in accordance with one embodiment of the present invention;

FIG. 6: is a flow chart of the process of creating/modifying rules in the Rule Builder in accordance with one embodiment of the present invention; and

FIG. 7: is a flow chart of a service entitlement request by the license server, GetSubscriberLicenseEntitlement Structured API, in accordance with one embodiment of the present invention.

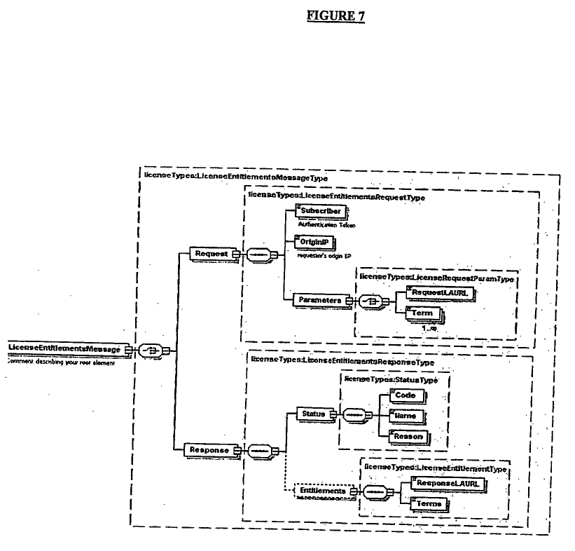

### DETAILED DESCRIPTION OF INVENTION

The following terms are provided to establish an understanding of the invention:
1. Media Provider: Content owner, distributing or reselling digital content, such as cable or wireless service providers.
2. Media Consumer: Consumer or customer of digital goods and services.
3. EIS: Enterprise Information Systems: existing data sources and technology applications within the media provider's infrastructure which may store information related to billing, customer and product information.
4. IP: Internet Protocol: specifies the format of packets (also called datagrams) and the addressing schemes.
5. Digital Media/Content: for the purpose of this invention, digital media or content refers to advertisements, games and audio/video content.
6. DRM: Digital Rights Management: security-based technologies that enable content owners to have control over how their content is-distributed transferred and consumed.
7. End-user Consumer: Person using an application, system or method.
8. Rule Engine: an intelligent engine used to design, develop, and manage business rules. For the purpose of this invention, it allows programmers and end-users to easily create and manage business rules in a robust, scalable and high performance environment.
9. Entitlement: For the purpose of this invention, entitlement refers to a system that facilitates the creation and management of rules that determine if something or someone has a right or claim to a particular digital media and the required interfaces for accessing this logic.
10. URL: Uniform Resource Locator: a unique address for a file, page or program. The URL contains the name of the protocol to be used to access the resource, a domain name that identifies a specific computer on the Internet, and a pathname, as well as a hierarchical description that specifies the location of a file in that computer.
11. Encryption: encryption is the conversion of data into a form called a ciphertext that cannot be easily understood by unauthorized people.
12. Decryption: decryption is the process of converting encrypted data back into its original form so that it can be understood.
13. OSS: Operational Support System: As defined by whatis.com, an OSS is a set of programs that help a communications service provider monitor, control, analyze, and manage problems with a telephone or computer network.

The present invention interacts with a number of external applications including those that issue requests to access content, licenses and bandwidth.

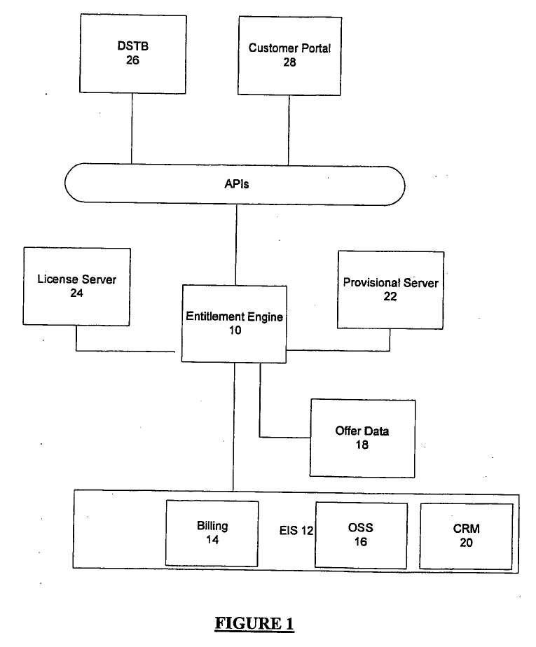

As shown in FIG. 1, the present invention Entitlement Engine 10 may be configured to couple with a media provider's EIS System 12. In this scenario, the media provider's EIS System 12 consists of Billing 14, Operational Support System (OSS) 16 and Customer Relationship Management (CRM) 18 Systems. Additionally, Entitlement Engine 10, interacts with a number of other applications including a customer Web Portal 28, digital set top box (DSTB) 26, License Server/Digital Rights Manager (DRM) 24 and Provisioning Server 22.

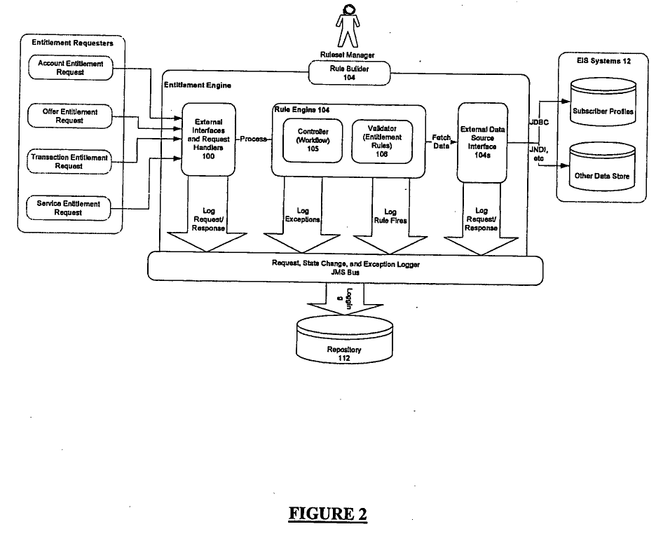

The components of Entitlement Engine 10 are depicted in FIG. 2 whereby its components and external connections are detailed asset forth below.

The Entitlement Engine 10 preferably includes, but is not limited to, four components, each playing its own role in executing a consumer's entitlement rights. The External Interfaces and Request Handler 100 serves as the inbound interface, the Rule Engine 104, acts as the heart of the invention and consists of 2 sub-components, Controller 105 which is responsible for the engine's workflow and the Validator 106 which is tasked with validating entitlement rules. Additionally, State, Change and Exception Logger 108 records all inbound and outbound requests, and finally the External Data Source Interface 102 handles communications with EIS Systems 12.

External Interface and Request Handler 100 is a set of inbound interfaces that accept entitlement requests. This component supports all protocols related to integrations with other computer applications and parses the entitlement request thereby extracting incoming data parameters. Further, it appropriately marshals and un-marshals each request and response using the internal common request object that is employed throughout the Entitlement Engine 10. Since Entitlement Engine 10 uses this common data format, it can be configured to listen to and accept requests using any technology protocol.

The second component is Rule Engine 104. This component is responsible for the processing of all entitlement requests. It contains the logic necessary for entitlement decisions as well as the logic that dictates the steps required to gather data for an entitlement decision. Rule Engine 104 encapsulates two logical subcomponents: Controller 105 and Validator 106. At the core of each. subcomponent is an internal Rule Engine 104 that provides centralized storage and management of critical business logic.

Controller 105 subcomponent uses information on the current state of a request and any available contextual data to determine which step to take next in the workflow.

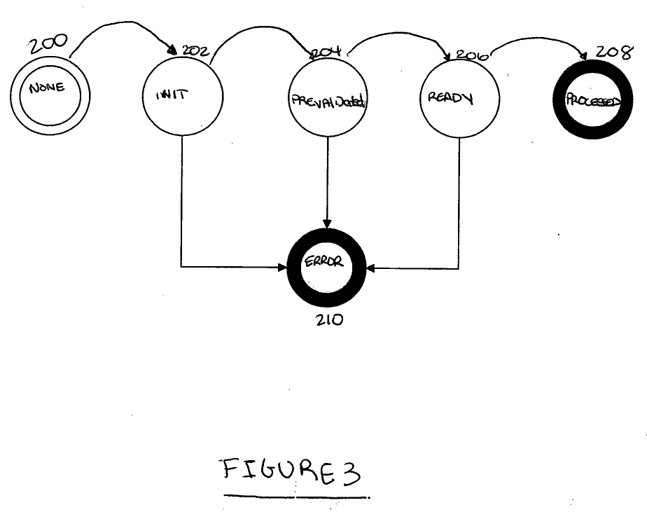

As illustrated in FIG. 3, there are six workflow states. The starting state 200 is NONE. This is the state of the Entitlement Engine Context object that occurs prior to the setting of any subscriber token data or request-identifying information. The Initialization state 202 is INIT; this is the state of the Entitlement Engine Context object that occurs after the subscriber token data and request-identifying information has been added. Next is the PREVALIDATION state 204; this state of the Entitlement Engine validates the presence and structure of the subscriber token data and request-identifying information it retrieves data from EIS 12 systems. Also, when signifying that data is ready, the READY state 206 is invoked. This state occurs after all data points required for entitlement decisions have been retrieved. Additionally, when a request is processed, the PROCESSED workflow state 208 is generated. Finally, ERROR state 210 is invoked when a processing error occurs during the workflow.

In order to make an entitlement decision, Validator 106 subcomponent tests the validity of the request's parameters including any data that was collected in previous steps 200-210. Validator's 106 Rule Engine changes the state of the request based on the results of the validation. If the state of the request is ERROR state 210 or COMPLETED state 208, control is returned to the request handler that initially called the CLE; otherwise, control is passed back to Controller 105 for further workflow processing.

An example of a rule where the state of the request is checked is one that fetches data pertinent to making an entitlement decision. If the request is in the INIT state 202, the request type may be “hasServiceEntitlement,” this workflow rule would dictate that the engine first make a request to the consumer profile database to obtain the consumer's entitlement data. Controller 105 would then decide on what other EIS Systems 12 it needed to connect to in order to gather all the data necessary to make the entitlement decision. Controller 105 would finish its execution of this step in the workflow and pass control to Validator 106.

At this time, Controller 105 would be stateless and requests would transition sequentially from an INIT state 202 to a PROCESSED state 208. It is contemplated that such workflow sessions could be modified to support the option of continuation.

Validator 106 may modify or even create data that is returned to the caller. For example, consumer data retrieved by Controller 105 may be examined for rules that determine whether or not the consumer is entitled to view a video at high resolution. If the consumer's data points did not fall within the proper thresholds (as dictated by the rules) the Rule Engine would modify the response so that it contains the URL for a low-resolution version of the requested video. In such a case Entitlement Engine 10 would not provide a simple “yes” or “no” answer; instead, it would add value by providing an alternative response to the consumer's request.

Another component of Entitlement Engine 10 is the State Change and Exception Logger 108. This component is responsible for logging application events (asynchronously) from Entitlement Engine 10. State Change and Exception Logger 108 can be configured to accept certain messages or to simply ignore them. If it receives a message, the message is stored in a database. It can also be configured to send messages for any type of event including but not limited to: 1) incoming requests and responses; 2) requests and responses to EIS systems; 3) requested state changes; 4) rule engine firings; and 5) application exceptions.

Finally, External Data Source Interface 102 provides the Entitlement Engine 10 with the interfaces required to appropriately request data from the media provider's EIS Systems 12. The component handles any necessary session pooling to data sources and maintains the physical connections. It is the only component that adjusts with changes to EIS-specific protocols, their data models and/or integration with additional EIS data stores. Information acquired from EIS Systems 12 are un-marshaled into objects and returned to Rule Engine 104.

Using the components set forth and described above, the present invention aggregates data from a diverse set of applications. It processes entitlement requests based on this data and transfers relevant information back to the requesting application. It securely responds to requests from external applications using flexible adapters and EIS drivers. Further, it is capable of initiating requests for information, e.g. to maintain up-to-date information on entitlement privileges.

In one embodiment, the present invention interoperates with multiple systems, an example situation is one wherein the consumer's DSTB 26 checks with Entitlement Engine 10 to ensure that the consumer is authorized to access content he/she requested. Entitlement Engine 10 requests a license key from License Server/DRM 24. License Server/DRM 24 takes on the task of requesting additional information about the customer's license rights and generates a license key. The present invention take a consumer's session id and entitlement request and cross-checks this information with entitlements, available offers and licenses in addition to authenticating the consumer's attributes with available EIS Systems 12. It then responds to the consumer's request with an authorization, alternative or decline to each request.

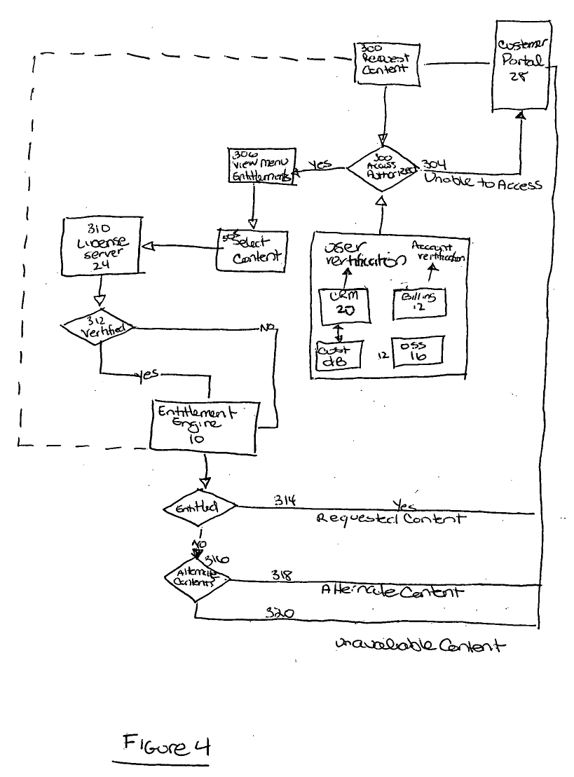

FIG. 4 depicts an example of such an entitlement request and approval process.

In a first step 300, a customer portal 28 requests content. Next, at an access authorization step 302 the system queries user and account verification information. If access is not authorized, the Customer Portal is informed of the denial at step 304. Alternatively, if access is authorized, then at step 306, Customer Portal 28 is allowed to view a menu of entitlements, at step 306.

Next, at step 308, the customer selects the desired content, a subscriber token is sent and a license key is requested from License Server 24 at step 310. At step 312, Entitlement Engine 10, determines whether or not the consumer is entitled to view the requested digital content. If so then at step 314, the requested content is delivered. If not, then at step 316 alternative content is explored. If alternative content is desirable/available, then at step 318 it is delivered to Customer Portal 28. Otherwise, a message indicating that the content is unavailable is delivered at step 320.

It is noted that dotted line 322, indicates an alternative scenario whereby Entitlement Engine 10 generates the license or otherwise bypasses License Server 24. Furthermore, it is noted that in one embodiment of the present invention, menu of entitlements from step 306 may not be required for operation of this process.

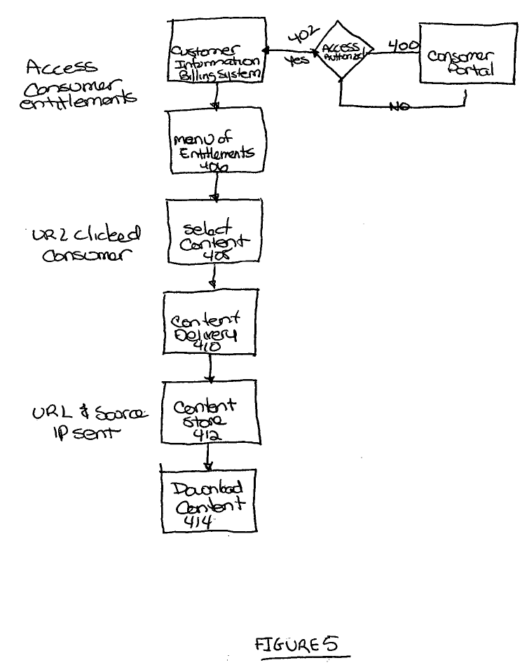

The present invention uses a combination of data access and rule engines to ensure that digital content is appropriately presented to the right consumer for purchase; it confirms the purchase of the content and securely protects it from the time of its request to the fulfillment stage. In one embodiment of the present invention, FIG. 5 illustrates how a consumer may access entitlements and then obtain the necessary authorization to download the desired content. Actions that can be performed by consumers include, viewing entitlements, downloading content, playing content and adjusting bandwidth.

At a first step 400, the consumer logs onto a portal where he/she may access digital media. Next, at step 402, the consumer's ID and password are validated. At step 404, the Customer Information database or the service provider's billing system 14 is queried to evaluate the customer's entitlements.

Next, at step 406, a menu of the individual entitlements is displayed to the consumer. At step 408, the consumer selects the desired content by clicking onto a URL in the portal menu. At step 410, the Content Delivery system directs the request to the appropriate Content Store. Next, at step 412, using the URL and source IP, the Content Store enables the consumer to download the content, which is downloaded by the consumer at step 414.

Although it is noted that the above-described processes are presented in a particular order, this is in no way intended to limit the scope of the present invention. Any similar group of steps performed in alternate sequences is also within the contemplation of the present invention.

Thus, in one embodiment of the invention consumers are armed with the tools necessary for accessing personalized content and associated entitlement information. For example, it enables consumers to predefine content and schedule it for future consumption. The invention not only tailors authorizations to the type of device, content and/or customer account being utilized, but it is also capable of intelligently suggesting alternate content offerings to a consumer if his/her account is denied access to a particular service or product. Alternate suggestions may be based on product attributes, consumer preferences or other types of configurable information.

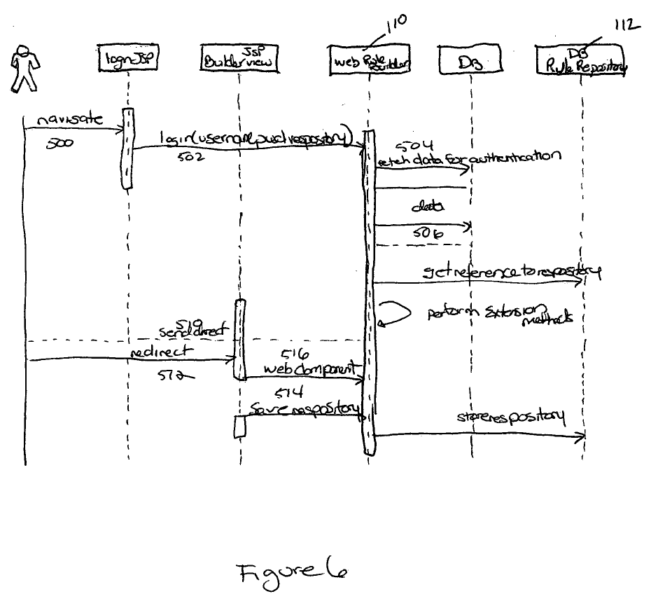

In one embodiment of the present invention, as illustrated in FIG. 6, access to built-in, context sensitive rule-sets via an intuitive Rule Builder 110 is provided for authoring entitlement policies and collecting customer/product attributes. Rule Builder 110 exposes a subset of the entitlement rules that may be accessible via an extensible and configurable Web-based rules management interface. The rules are written in high-level business language and consist of a list of parameters needed to make a decision. End-users (e.g. a media provider's Systems Administrator) may use existing rules, customize them, add their own conditions if suitable ones do not exist and/or incorporate information from various backend data systems into the rules of Entitlement Engine 10. Entitlement rules may be modified, deleted or saved as templates for future use. Additionally, end-users may set priorities for processing entitlements. Furthermore, these rules may be searched and/or archived based on either predefined or user-defined categories.

FIG. 6 illustrates the process of creating an entitlement rule. At step 500, the end-user navigates to the login page of the Web-based rule management console, where he/she at step 502 enters his/her login credentials and selects a rule repository to access. Rule Builder 110 at step 504 authenticates the end-user's credentials against its data store (or rule repository) 112. If authentication succeeds, then at step 506 Rule Builder 110 checks whether or not the end-user has the proper authorizations to access the requested repository. Next, at step 508, Rule Builder 110 retrieves references to rule repository 112 and initializes the Web components at step 510, thereby redirecting the end-user's browser at step 512 to the proper repository viewing JSP page. The end-user is able to modify rules according to his/her permissions. When the end-user is ready to Save, the Save Request step 514 triggers Rule Builder 110, which in turn makes the appropriate API calls at step 516 and stores the changes in rule repository database 112 at step 518.

It is prudent to note that the present invention is capable of supporting all types of digital content including video, games and digital advertisements on multiple types of devices including PCs, TVs and game consoles. As such, it is designed to support the creation, management and processing of any type of entitlement rule. Typically, an entitlement rule may determine whether or not a customer is eligible to consume a digital file.

In one embodiment of the invention, six types or instances of entitlement rules may be created. These rules may or may not share a common set of rules. Also, each instance of entitlement can be managed and administered individually or collectively. Subscriber Entitlement is one such entitlement rule; it is concerned with rules that determine a consumer's eligibility and the right to access based on a subscriber's status at the start of the ordering process. On the other hand, License Entitlement rules are used to determine license parameters that are associated with a specific piece of content. Also, an entitlement rule that may be may be invoked frequently is an Offer Entitlement as it deals with business rules associated with the perquisites necessary to view and/or purchase a specific service or product offer, e.g. a sports package specifically tailored to subscribers in a particular geographic location. Transaction Entitlement is another example of an entitlement rule; it may be used to determine whether or not a particular account is capable of making a transaction and/or a purchase. When the request is made for delivery, the Entitlement Engine 10 triggers the logic that fulfills the funding obligation of the consumer. Additionally, Service Entitlement is a rule type that is concerned with accessing content or licenses on previously purchased services and products. This instance of entitlement decides on one's right to ultimately play and consume content. Finally, Access Entitlement may be used by end-users for setting parental-type controls based on the consumer's primary or secondary account status.

To process the rule, information about the consumer (subscriber), the file that was requested (URL) and the type of license that was requested (one-time) is used by the invention. Entitlement Engine 10 responds to content requests with a (Return Value) and assesses the state of the request (Status) in order to determine whether or not the customer should be given access to the desired content. If the status is granted, the terms under which access was granted is provided; otherwise, the reason why access was denied is explained:

getSubscriberLicenseEntitlements

Arguments
Subscriber: Authentication Token
File: URL
License type requested: Online, portable, one-time, etc.
Protocol: Not required

Return Value
Status: denied, granted
Terms: online only, portable, number of plays, expiration date, expiration past, first play Reason: string.

Security is an integral part of the present invention. The invention is designed in such a way that an end-user's capabilities and performable actions are based on his/her permissions. Thus access to information is based on the identity of the requester and content. Additionally, data associated with entitlement requests is encrypted while being transferred to and from other applications.

Therefore, in view of the forgoing structure and processes, it is understood that that the present invention is responsible for 3 key tasks: enabling entitlement rules creation, processing entitlement requests and furnishing the interfaces for communicating with multiple sources of information in a secure manner. It is a configurable tool that automates the rules management process on behalf of those distributing digital content. The invention's core responsibility is to gather a collection of attributes from a variety of data stores and execute them via defined rule-sets. It provides flexibility in the ways in which rules for content offerings are structured and makes it possible for media providers to easily integrate their applications with external applications while maintaining data integrity. The invention uses its access control, filtering, and intelligent routing capabilities to offer fine-grained content availability based on caller context such as account status, transaction history, content meta-data, and other external business conditions.

Furthermore, the present invention facilitates the creation and management of business rules that determine if a consumer or his/her device has a right to claim the requested offer, digital media, or play capabilities. It provides the mechanisms necessary for end consumers to view entitlement rights as well as access, order and consume content on their own terms. The invention provides increased variety to consumers as it facilitates flexibility in content type, price plan and accessing device. Additionally, it enables them to receive content based on their preferences as well as receive alternate offerings that may be based on criteria deemed valuable to them.

While only certain features of the invention have been illustrated and described herein, many modifications, substitutions, changes or equivalents may be devised by those skilled in the art. It is therefore, to be understood that this application is intended to cover all such modifications and changes that fall within the true spirit of the invention.

What is claimed is:

1. A system for creating and processing customer entitlement rules regarding digital content, said system comprising:
a first interface for creating customer entitlement rules; a second interface for communicating with a portal for consuming digital content entitled to; and
an entitlement engine for processing said entitlements, said system configured to interface with a plurality of modules in order to obtain data needed to make entitlement decisions, said entitlement engine allowing digital content providers to track, secure and manage entitlements for said digital content.

2. A system as claimed in claim 1, wherein said entitlement engine is coupled to a digital content provider's enterprise information system so as to access any one of customer billing, customer preferences and product information.

3. A system as claimed in claim 1, wherein said entitlement engine is further coupled to a license server configured to provide said entitlement engine information pertaining to customer licenses to either access, consume or purchase a particular digital content.

4. A system as claimed in claim 1, wherein said entitlement engine further comprises an external interface and request handler, rule engine, state change and exception logger and an external data source interface.

5. A system as claimed in claim 4, wherein said external interface and request handler includes a set of inbound interfaces that accept entitlement requests.

6. A system as claimed in claim 4, wherein said state change and exception logger logs application events from said system.

7. A system as claimed in claim 4, wherein said external data source interface provides said system with interfaces required to appropriately request data from external systems.

8. A system as claimed in claim 4, wherein said rule engine processes all entitlement requests and contains the logic necessary for entitlement decisions.

9. A system as claimed in claim 8, wherein said rule engine further comprises a controller logic that uses information on the current state of a request to determine which step to take in a workflow.

10. A system as claimed in claim 9, wherein said rule engine further comprises validator logic that tests the validity of request parameters and changes the state of the request based on the results of the validation.

11. The system claimed in claim 1, wherein said system makes decisions, based on entitlement rules established by media providers, that enable customers to view, download or play digital content as well as adjust bandwidth and/or share a variety of different types of content over a plurality of devices, whereby said system supports the exchange of any type of digital content including audio, video or games over devices including PCs, TVs, PDA's and game consoles.

12. A system as claimed in claim 1, wherein said entitlement engine supports any one of a customer's initiation of an order of a digital product or service based on subscriber entitlements; initiating requirements for viewing and/or purchasing a digital offer or package; using license parameters associated with a specific piece of content; validating rules for a transaction; posting transaction policies on purchased services or products; and providing parental-type controls.

13. The system as claimed in claim 12, wherein said parental-type controls are based on a customer's primary or secondary account status.

14. A system as claimed in claim 1, wherein said system enables said media providers to create, modify and delete rules for customer access rights whereby said media providers may either employ existing rules, customize rules, add their own conditions to rules if suitable ones do not exist, incorporate information from various backend data systems, or set priority levels based on which license takes precedence.

15. A system as claimed in claim 13, further comprising the step of: accessing said system via a web-based rule builder allowing said media provider or an end-user to create, modify or delete customer entitlement information.

16. A system as claimed in claim 1, whereby:
if said customer is entitled, providing authorization to said customer for obtaining said particular content; and
if said customer is not entitled, providing an alternative choice to said customer for a second digital content, apart from the content requested, upon which said customer is entitled to receive.

17. A system as claimed in claim 16, wherein said entitlement engine may provide alternate suggestions to a customer portal with the ability to base said alternate suggestions on at least any one of product attributes or customer preferences.

18. A system as claimed in claim 15, whereby the method by which entitlement rules are created or modified via said rule builder and processed with said system and consumed via a customer portal can be handled in real time.

19. A system for creating and processing customer entitlement rules regarding digital content, said system comprising:
a first interface for creating customer entitlement rules; a second interface for communicating with a portal for consuming digital content entitled to;
an entitlement engine for processing said entitlements, said entitlement engine having an external interface and request handler, rule engine, state change and exception logger and an external data source interface;
said entitlement engine being coupled to a digital content provider's enterprise information system so as to access any one of customer billing, customer preferences and product information;
said entitlement engine further being coupled to a license server configured to provide said entitlement engine information pertaining to customer licenses to either access, consume or purchase a particular digital content; and
wherein said system is configured to interface with a plurality of modules in order to obtain data needed to make entitlement decisions, said entitlement engine allowing digital content providers to track, secure and manage entitlements for said digital content.

20. A system as claimed in claim 19, wherein said external interface and request handler includes a set of inbound interfaces that accept entitlement requests.

21. A system as claimed in claim 19, wherein said state change and exception logger logs application events from said system.

22. A system as claimed in claim 19, wherein said external data source interface provides said system with interfaces required to appropriately request data from external systems.

23. A system as claimed in claim 19, wherein said rule engine processes all entitlement requests and contains the logic necessary for entitlement decisions.

24. A system as claimed in claim 23, wherein said rule engine further comprises a controller logic that uses information on the current state of a request to determine which step to take in a workflow.

25. A system as claimed in claim 24, wherein said rule engine further comprises validator logic that tests the validity of request parameters and changes the state of the request based on the results of the validation.

26. The system claimed in claim 19, wherein said system makes decisions, based on entitlement rules established by media providers, that enable customers to view, download or play digital content as well as adjust bandwidth and/or share a variety of different types of content over a plurality of devices, whereby said system supports the exchange of any type of digital content including audio, video or games over devices including PCs, TVs, PDA's and game consoles.

27. A system as claimed in claim 19, wherein said entitlement engine supports any one of a customer's initiation of an order of a digital product or service based on subscriber entitlements; initiating requirements for viewing and/or purchasing a digital offer or package; using license parameters associated with a specific piece of content; validating rules for a transaction; posting transaction policies on purchased services or products; and providing parental-type controls.

28. The system as claimed in claim 27, wherein said parental-type controls are based on a customer's primary or secondary account status.

29. A system as claimed in claim 19, wherein said system enables said media providers to create, modify and delete rules for customer access rights whereby said media providers may either employ existing rules, customize rules, add their own conditions to rules if suitable ones do not exist, incorporate information from various backend data systems, or set priority levels based on which license takes precedence.

30. A system as claimed in claim 28, further comprising the step of: accessing said system via a web-based rule builder allowing said media provider or an end-user to create, modify or delete customer entitlement information.

31. A system as claimed in claim 19 whereby:
if said customer is entitled, providing authorization to said customer for obtaining said particular content; and
if said customer is not entitled, providing an alternative choice to said customer for a second digital content, apart from the content requested, upon which said customer is entitled to receive.

32. A system as claimed in claim 31, wherein said entitlement engine may provide alternate suggestions to a customer portal with the ability to base said alternate suggestions on at least any one of product attributes or customer preferences.

33. A system as claimed in claim 30, whereby the method by which entitlement rules are created or modified via said rule builder and processed with said system and consumed via a customer portal can be handled in real time.

34. A method for creating and processing customer entitlement rules regarding digital content, said method comprising the steps of:
creating customer entitlement rules at a first interface;
communicating with a portal for consuming digital content entitled to at a second interface; and
processing said entitlements at an entitlement engine, said method including an interfacing with a plurality of modules in order to obtain data needed to make entitlement decisions, said entitlement engine allowing digital content providers to track, secure and manage entitlements for said digital content.

35. A method for creating and processing customer entitlement rules regarding digital content, said method comprising the steps of:
creating customer entitlement rules at a first interface;
communicating with a portal for consuming digital content entitled to at a second interface;
processing said entitlements at an entitlement engine, said entitlement engine having an external interface and request handler, rule engine, state change and exception logger and an external data source interface;
accessing any one of customer billing, customer preferences and product information by way of a digital content provider's enterprise information system coupled to said entitlement engine;
providing said entitlement engine information pertaining to customer licenses to either access, consume or purchase a particular digital content by way of a license server coupled to said entitlement engine; and
said method including an interfacing with a plurality of modules in order to obtain data needed to make entitlement decisions, said entitlement engine allowing digital content providers to track, secure and manage entitlements for said digital content.
